(19) United States
(12) Patent Application Publication
(10) Pub. No.: US 2009/0091591 A1
(43) Pub. Date: Apr. 9, 2009

(54) Printing Systems And Methods For Generating Relief Images

(76) Inventors: Yohanan Sivan, Raanana (IL); Ran Waidman, Rehovot (IL); Shlomo Harush, Nes Ziona (IL)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/868,523

(22) Filed: Oct. 7, 2007

(51) Int. Cl. B41J 29/38

(52) U.S. Cl. 347/9

(57) ABSTRACT

Systems and methods for generating relief images are disclosed. In an exemplary embodiment, a printing method for generating relief images may include transferring a plurality of ink layers one on top of the other on a substrate. The method may also include transferring at least one ink pixel on the plurality of ink layers. The method may also include outputting a relief image that appears differently based on a viewing angle of an observer.

### BACKGROUND

Color printers have become increasingly more commonplace with advances in printing technologies. High-quality, inexpensive color printers are readily commercially available in a wide variety of sizes ranging from portable and desktop inkjet printers for use at home or at the office, to large commercial-grade color printers.

Traditionally, printers were used primarily for printing text documents. Today, however, color printers are available and are routinely used to print complex images, such as digital photographs. Often it is difficult to distinguish color printed images from developed film photographs. However, these images are generally two-dimensional in nature.

Although three-dimensional printing technology is available, e.g., for coloring three-dimensional objects (typically artwork), these printers are generally expensive and only used for specialty jobs. A lenticular technique is also known, wherein a lens is layered over the print to give the image a different appearance when viewed from different angles. This technique has been employed primarily to create “cereal-box” toys for children.

### BRIEF DESCRIPTION OF THE DRAWINGS

FIG. 1 is a high-level illustration of an exemplary printing system which may be implemented for generating relief images.

FIG. 2a is a top plan view of an exemplary relief image.

FIG. 2b is a side cross-sectional view of the exemplary relief image shown in FIG. 2a taken along lines 2b-2b.

FIG. 3a is a top plan view of an exemplary relief image.

FIG. 3b is a side cross-sectional view of another exemplary relief image shown in FIG. 3a taken along lines 3b-3b.

FIG. 4 is a flowchart illustrating exemplary operations which may be implemented for generating relief images.

### DETAILED DESCRIPTION

Exemplary systems and methods for generating relief images are disclosed. In an exemplary embodiment, layers of ink are transferred one on top of the other on a substrate (e.g., paper) using an inkjet printer, LEP printer, or other suitable printing system. The layers of ink form “hills and valleys” on the substrate. A different color ink may then be printed on a side of the hills and valleys (and/or on top of a “hill” or within a “valley”).

The relief image appears different to an observer based on a viewing angle of the observer. Accordingly, the relief image may be used in any of a wide variety of applications, including, but not limited to, security applications because the relief image cannot be easily reproduced using conventional copying or scan-and-print techniques. Optionally, the relief image may be used to represent digital data.

### Exemplary Systems

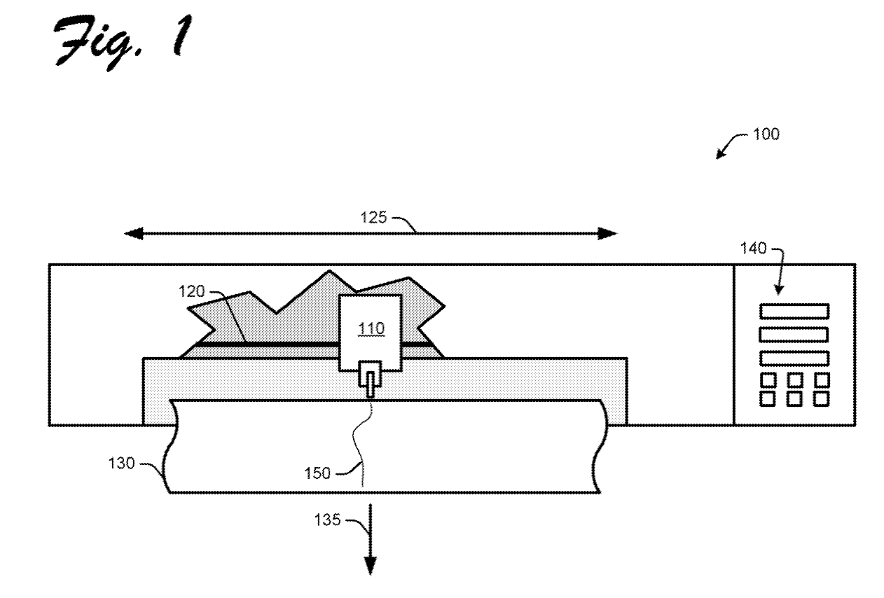

FIG. 1 is a high-level illustration of an exemplary printing system which may be implemented for generating relief images. Exemplary printing system may be implemented as an inkjet printer 100, or other suitable printer now known or later developed.

Inkjet printer 100 may include one or more inkjets 110 provided to move along rail 120 in at least two directions (e.g., the directions illustrated by arrow 125) as a substrate (e.g., paper 130) is fed through the printer (e.g., in the directions illustrated by arrow 135). A controller (not shown) may be provided to control operations. Optionally, the controller may be operatively associated with an external control panel 140 for input/output by a user; and the controller may be operatively associated with an external device (not shown), such as a computer or other electronic device for input/output by the device.

In any event, the controller may be operatively associated with a driving mechanism (not shown) to move the inkjet 110 along the rail 110 in the directions illustrated by arrow 125, and a feed mechanism (not shown) to move the paper adjacent the inkjet 110 in the directions illustrated by arrow 135. The controller may also be operatively associated with one or more inkjet cartridges fluidically connected to the inkjet 110 to control the flow of ink through the inkjet 110 for transfer on the substrate (e.g., as illustrated in FIG. 1 by line 150 on paper 130).

Before continuing, it is noted that the systems and methods described herein are not limited to the inkjet printer 100 described above with reference to FIG. 1. For example. Liquid Electro-photographic (“LEP”) printers (not shown) may also be implemented, such as the Indigo series of LEP printers (e.g., the Indigo Press 4050 commercially available from Hewlett-Packard Co.; Palo Alto, Calif.).

Briefly, the LEP printing process involves placing a uniform electrostatic charge on a photo imaging plate (“PIP”) and exposing the PIP to a light and shadow image or to a scanning laser to dissipate the charge on the areas of the PIP exposed to the light arid then forming a latent electrostatic image. The resulting latent image is developed by subjecting the latent image to a liquid toner comprising a carrier liquid and colored toner particles. These toner particles are generally comprised of a pigmented polymer. Generally, the development is carried out, at least partially, in the presence of an electric field, such that the toner particles are attracted either to the charged or discharged areas, depending on the charge of the particles and the direction and magnitude of the field.

The image may then be transferred to a substrate such as paper or plastic film, often via an intermediate transfer member (“ITM”) which is typically covered with a replaceable blanket. The transferred image may then be permanently affixed to the substrate by the application of pressure, heat solvent, over-coating treatment or other affixing processes. In general, in the commercial process used by HP-Indigo, the ITM is heated to a temperature that causes the toner particles and residual carrier liquid to form a film in the printed areas which is transferred to the final substrate by heat and pressure. Fixing to the final substrate may also be part of the transfer process.

It is noted that the construction and operation of printing systems described above are well understood in the computer and printer arts and therefore further description is not necessary for a full understanding of the systems and methods described herein.

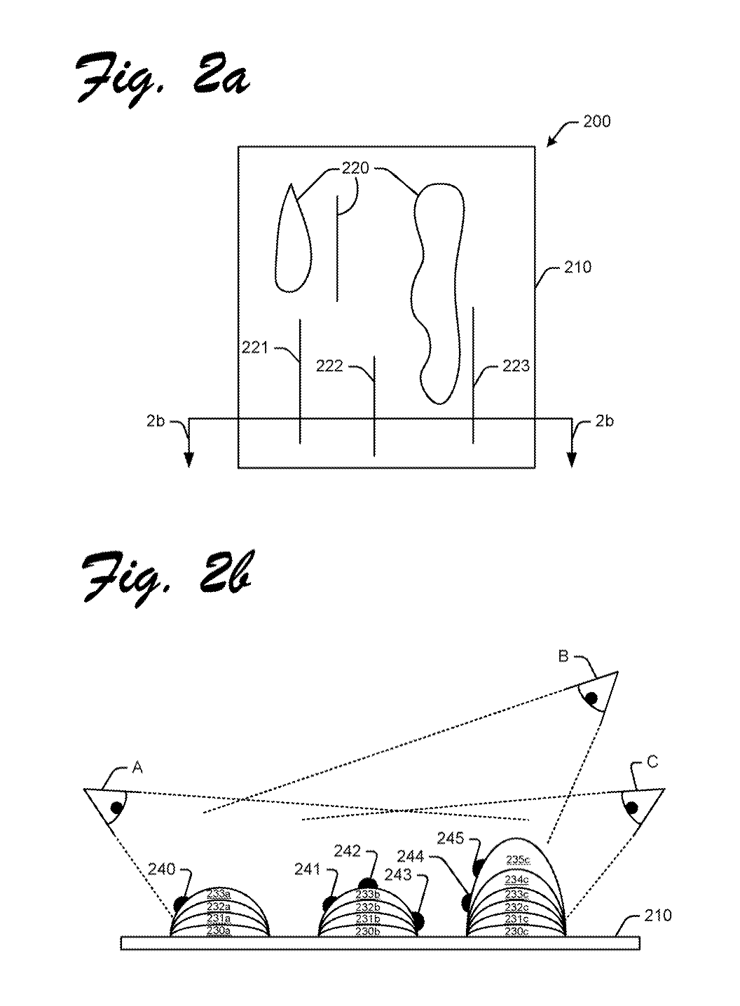

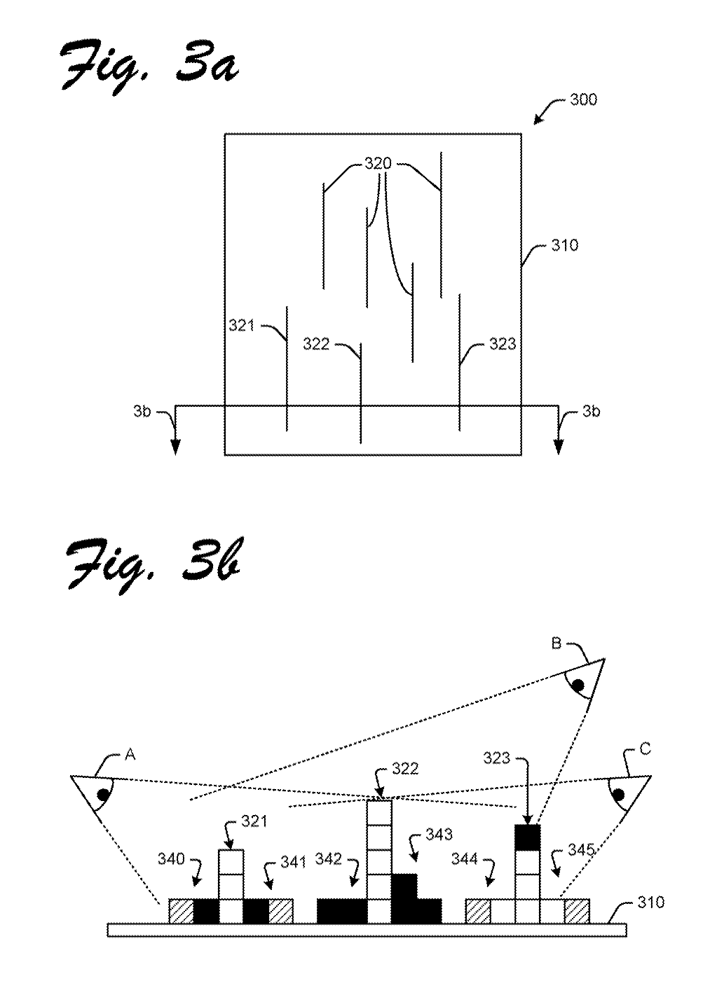

In any event, the printing system (e.g., inkjet printer 100 or LEP printer) may be used to transfer layers of ink one on top of the other on a substrate (e.g., the paper 130). These layers of ink form “hills and valleys” on the substrate. A different color ink may then be printed on a side of the hills and valleys (and/or on top of a “hill” or within a “valley”) to generate a relief image, as explained in more detail below with the exemplary embodiments shown in FIGS. 2a-b and FIGS. 3a-b.

FIG. 2a is a top plan view of an exemplary relief image 200. FIG. 2b is a side cross-sectional view of the exemplary relief image 200 shown in FIG. 2a taken along lines 2b-2b. Exemplary relief image 200 may be generated using a printing system such as the inkjet printer 100 described above with reference to FIG. 1 or other suitable printing system (e.g., the LEP printer, also described above).

In an exemplary embodiment, a relief image may comprise layers of ink one on top of the other on a substrate 210 (e.g., paper). The layers of ink form “hills” (e.g., indicated by lines 220 and lines 221-223 in FIG. 2a) and “valleys” (e.g., indicated by the space between lines 220 and lines 221-223 in FIG. 2a) on the substrate 210.

The layers of ink can be best seen in the cross-sectional view shown in FIG. 2b. The layers of ink may be transferred on the substrate by the printing system using conventional printing techniques. In an exemplary embodiment, a first layer of ink (e.g., layer 230a-c) corresponding to hills 221-223 in FIG. 2a, respectively, is transferred and allowed sufficient time to dry before transferring the second layer of ink (e.g., layer 231a-c), and so forth for subsequent layers of ink.

Dry time between printing the different layers will depend on one or more design considerations such as the ink properties, but is typically on the order of a fraction of a second to a few seconds. Ink properties may include color, size, viscosity and dimension, all of which may be selected based on any of a wide variety of design considerations. Design considerations may include, but are not limited to, the desired width of the ink layers, the desired height of the “hills,” the desired depth of the “valleys,” the desired properties and/or uses of the finished product, etc.

In an exemplary embodiment, the ink may be eight layers high, although other embodiments are also contemplated wherein more or less layers are stacked. Indeed, the ink may be a different number of layers at different positions on the substrate 210 to achieve the desired effect (e.g., as illustrated by stacks for lines 221 and 222 as compared to the higher stack for line 223). In any event, the substrate may be positioned to achieve the desired pattern and then repeated to stack each of the desired number of layers as the respective positions.

After transferring the desired number of ink layers to create the hills and valleys, one or more ink pixels 240-245 (generally referred to as ink pixel 240) may be transferred at various vertical positions on the layers of ink. In an exemplary embodiment, ink pixels 240 are a different color from the layers of ink to create a contrast. The ink pixels may be transferred as individual pixels, as multiple pixels, and/or as lines, depending at least in part, on the desired effect the user desires to achieve when viewing the relief image 200.

The relief image 200 appears different to an observer based on a viewing angle of the observer. For example, an observer may see different colors and/or patterns when viewing the relief image 200 from positions A, B, and C (or other positions, not shown) as a result of the different vertical positions of the ink pixels 240 on the layers of ink.

FIG. 3a is a top plan view of an exemplary relief image. FIG. 3b is a side cross-sectional view of another exemplary relief image shown in FIG. 3a taken along lines 3b-3h. Exemplary relief image 300 represents “digital data” and may also be generated using a printing system such as the inkjet printer 100 described above with reference to FIG. 1, the LEP printer also described above, or other suitable printing system.

In an exemplary embodiment, relief image 300 may comprise layers of ink one on top of the other on a substrate 310 (e.g., paper). The layers of ink form “hills” (e.g., indicated by lines 320 and lines 321-323 in FIG. 3a) and “valleys” (e.g., indicated by the space between lines 320 and lines 321-323 in FIG. 3a) on the substrate 310.

The layers of ink can be best seen in the cross-sectional view shown in FIG. 3b. Here, the layers of ink are discrete pixels, each pixel having substantially the same dimensions to better represent “digital” (a combination of 0's and 1's) data. Again, the layers of ink may be transferred on the substrate by the printing system using conventional printing techniques similar to those described above with reference to FIGS. 2a-b.

After transferring the desired number of ink layers to create the hills and valleys, one or more ink pixels 340-345 (generally referred to as ink pixel 340) may be transferred at various positions adjacent the layers of ink (or on the layers of ink as illustrated by stack 323). In an exemplary embodiment, ink pixels 340 are a different color from the layers of ink to create a contrast. The ink pixels may be transferred as individual pixels, as multiple pixels, and/or as lines, depending at least in part on the desired effect the user desires to achieve when viewing the relief image 300.

The relief image 300 appears different to an observer based on a viewing angle of the observer. For example, an observer may see different colors and/or patterns when viewing the relief image 300 from positions A, B, and C (or other positions, not shown) as a result of the different vertical and horizontal positions of the ink pixels 340 and the height(s) of the layers of ink.

### Exemplary Operations

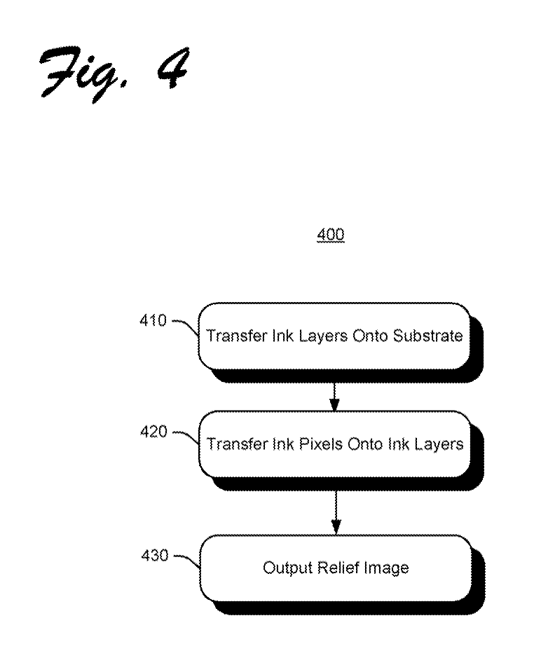

FIG. 4 is a flowchart illustrating exemplary operations which may be implemented for generating relief images. In an exemplary embodiment, operations 400 may be embodied as logic instructions on one or more computer-readable media. When executed on a processor, the logic instructions cause a general purpose computing device to be programmed as a special-purpose machine that implements the described operations. The components and connections depicted in the figures may be used for generating relief images. In other embodiments, the operations 400 may be executed manually.

In operation 410, a plurality of ink layers are transferred onto a substrate. For example, the plurality of ink layers may be formed from a plurality of individual ink pixels that are substantially the same in color, size, and dimension. In any event, the plurality of ink layers may create a hill and valley effect on the substrate.

In operation 420, at least one ink pixel is transferred on the plurality of ink layers. For example, the ink pixel(s) may be transferred to one or both sides of the ink layers. Some ink pixels may also be transferred on the top of the ink layers. However, at least one ink pixel should be transferred on a side of the ink layers to create the desired effect.

In operation 430, a relief image is output that appears differently based on a viewing angle of an observer. In an exemplary embodiment, the relief image represents digital data. The relief image may be used for any of a wide variety of applications, including but not limited to, security. That is, a document cannot be easily reproduced using conventional copying or sean-and-print techniques.

The operations shown and described herein are provided to illustrate exemplary implementations for generating relief images. It is noted that the operations are not limited to the ordering shown. Still other operations may also be implemented.

The exemplary embodiments shown and described herein are provided for purposes of illustration and are not intended to be limiting. Still other embodiments are also contemplated for generating relief images.

1. A printing method for generating relief images, comprising;
transferring a plurality of ink layers one on top of the other on a substrate;
transferring at least one ink pixel onto the plurality of ink layers; and
outputting a relief image that appears differently based on a viewing angle of an observer.

2. The method of claim 1, wherein the at least one ink pixel is a different color from the ink layers.

3. The method of claim 1, wherein the at least one ink pixel is transferred to a side of the ink layers.

4. The method of claim 1, wherein the output relief image represents digital data.

5. The method of claim 1, wherein transferring the plurality of ink layers creates a hill and valley effect on the substrate.

6. The method of claim 1, wherein the plurality of ink layers have substantially the same properties.

7. The method of claim 1, further comprising forming the plurality of ink layers from a plurality of individual ink pixels.

8. The method of claim 7, the plurality of individual ink pixels have approximately a 40:1 diameter to height ratio.

9. The method of claim 7, the plurality of individual ink pixels are approximately 40 μm in diameter and have a height of approximately 1 μm.

10. A printing system comprising:
at least two colors of ink; and
a controller programmed to transfer a first colored ink as ink layers onto the substrate, and then to transfer at least a second colored ink onto the ink layers to generate a relief image that appears different to an observer based on a viewing angle of the observer.

11. The printing system of claim 10, wherein the printing system is an LEP printer.

12. The printing system of claim 10, wherein the relief image represents digital data.

13. The printing system of claim 10, wherein the ink layers form a hill and valley effect on the substrate.

14. The printing system, of claim 10, wherein the ink layers are substantially the same in color and size.

15. The printing system of claim 10, further comprising forming the ink layers from a plurality of individual ink pixels.

16. The printing system of claim 15, wherein the individual ink pixels have approximately a 40:1 diameter to height ratio.

17. The printing system of claim 15, wherein the individual ink pixels are approximately 40 μm in diameter and have a height of approximately 1 μm.

18. A printing system for generating relief images, comprising:
means for layering the same color ink on a substrate to create a plurality of hills and valleys on the substrate; and
means for transferring at least one different colored ink pixel on the hills and valleys such that the resulting image appears different to an observer based on a viewing angle of the observer.

19. The printing system of claim 18, wherein the means for transferring transfers the at least one different colored ink on a side of the hills and valleys.

20. The printing system of claim 18, wherein the resulting image represents digital data.
